(19) United States
(12) Patent Application Publication
(10) Pub. No.: US 2009/0052977 A1
(43) Pub. Date: Feb. 26, 2009

(54) Brush with cartridge storage and cartridge content dispensing feature

(76) Inventor: Michael DellaCorte, Floral Park, NY (US)

Correspondence Address: Russ Weinzimmer, 614 Nashua St. #204, Milford, NH, 03055, US

(21) Appl. No.: 11/895,694

(22) Filed: Aug. 25, 2007

(51) Int. Cl. A46B 11/02; A46B 11/00; B67D 5/00; B67D 5/42; A46B 11/04

(52) U.S. Cl. 401/291; 401/186; 222/1; 222/326; 401/129; 401/140; 401/134

(57) ABSTRACT

A system (1) for dispensing a single dose premeasured liquid, gel, cream or paste from a cartridge (9). The system (1) includes a brush handle (3) and brush head (4). The cartridge (9) is placed within the brush handle (3) and advanced toward the head (4) by means of a plunger (11) or a lever (34). A pick (13) punctures the cartridge (9) as the plunger advances toward the head (4). A series of orifices (6, 7, 38, 39) permit the contents of the punctured cartridge (9) to flow onto the brush bristles (5).

### FIELD OF THE INVENTION

The present invention relates generally to the field of materials that may be applied by means of a brush, and more particularly to brushes having a container for the material to be applied.

### BACKGROUND OF THE INVENTION

Brushes are commonly used by persons while engaging in personal grooming activities and when applying certain types of medications. A problem inherent in using a brush is the initial step of applying to the brush the material ultimately intended for application to the body. The amount to be dispensed is difficult to measure, frequently resulting in an excessive application of products like toothpaste and hair cream. In particular, the user is not typically aware of the effective amount needed, and so errs on the side of over application by covering most or all of the exposed brush surface area. Another problem in applying paste like materials to a brush is caused by the differing viscosities of the paste material and the resistance offered by the paste container, especially when the paste container is quite full or nearly empty. When applying such materials excessive force can easily be applied to the paste or cream container resulting in the dispensing of surplus material which must then be discarded.

Past attempts have been made to simplify the use of a brush by combining the material to be dispensed with the brush itself. For example, U.S. Pat. No. 5,425,591, entitled “DISPOSABLE TOOTHBRUSH”, issued to Contreras, et al. on Jun. 20, 1995, discloses a toothbrush having a handle in which toothpaste is stored. Attached to the handle is a flexible hose that must be manipulated by the user so that toothpaste is drawn from the handle and deposited on the toothbrush bristles. While the Contreras et al. device relieves the user of the burden of obtaining a separate tube of toothpaste, the problem of accurate dispensing of an effective yet not excessive amount of toothpaste onto the brush bristles is not addressed. Further, multiple uses of the toothbrush are not envisioned.

Another toothpaste dispensing system is disclosed in U.S. Pat. No. 2,527,741, entitled “PASTE DISPENSING MEANS FOR TOOTHBRUSHES”, issued to Lamonde on Oct. 31, 1950. In the Lamonde device, a tube of toothpaste is stored in the enlarged toothbrush handle. A manual tube compression element abuts the toothpaste tube and is squeezed by the user. As the tube is compressed, the toothpaste exits the tube and enters a channel that terminates at an orifice within the brush head and adjacent to the base of the bristles. The problem of dispensing an effective yet not excessive amount of toothpaste is not addressed.

A similar device is disclosed in U.S. Pat. No. 6,397,859, entitled “TOOTHBRUSH ASSEMBLY”, issued to Byrd on Jun. 4, 2002. The Byrd device is ostensibly designed for dispensing a single use quantity of toothpaste from the handle of a toothbrush handle through a channel, exiting an orifice in the brush head at the base of the bristles. A plunger or piston is advanced by the user to force toothpaste through the channel. The toothpaste reservoir within the handle “may not be refilled with toothpaste” and the dimensions of the reservoir “are deemed readily apparent and obvious to one skilled in the art”. In fact, the device as illustrated appears to include a reservoir of toothpaste far in excess of a minimum effective amount, and the user is again left with the task of deciding when an effective yet not excessive amount of toothpaste has been applied to the brush bristles.

None of the Contreras et al., Lamonde and Byrd devices permit a person who is dispensing a paste like material onto a brush to automatically apply an effective yet not excessive amount of the paste to the brush surface. While such imprecision is tolerable, although wasteful, with staple goods like toothpaste, such dispensing systems are unacceptable where the material being dispensed is a prescription drug that affects the safety and well being of the user. What is needed is a brush dispensing system which houses the material to be dispensed and which also provides the automated dispensing of a safe and effective quantity of the paste or cream to the bristles of the brush without requiring judgment or skill on the part of the user.

### SUMMARY OF THE INVENTION

The system of the present invention includes a single use cartridge that is housed within a brush and which dispenses the contents of the cartridge onto a brush. The contents of the cartridge may be a paste, cream, gel or other relatively high viscosity, flowable material. The cartridge may contain, for example, a consumer item such as toothpaste, hair cream or nonprescription antibiotics, or the cartridge may contain a prescription medication intended for application to the skin, nails, teeth or hair. In either case, the cartridge contains a precisely measured amount of flowable material that is substantially dispensed in its entirety when the cartridge is accessed by the cartridge emptying mechanism.

In a preferred embodiment of the invention a single premeasured cartridge is be loaded into storage and dispensing chamber within the brush body. The cartridge may be loaded into the brush via an access port in the brush handle or brush head. When application of the material within the cartridge is desired a plunger is advanced so as to position the cartridge to a resiliently mounted pick. The pick punctures the cartridge and the head of the plunger advances throughout the original volume of the cartridge, forcing the contents of the cartridge through a plurality of orifices adjacent to the bristles. A plate formed behind the plunger head tends to completely fill the original cartridge volume while sealing the orifices after the material has been dispensed.

### BRIEF DESCRIPTION OF THE DRAWINGS

FIG. 1 is a schematic perspective view of a brush assembly constructed according to the principles of the present invention;

FIG. 2 is a schematic cross sectional view taken along line 2-2 in FIG. 1 showing the plunger in a first position;

FIG. 3 is a schematic cross sectional view taken along line 2-2 in FIG. 1 showing the plunger in a second position;

FIG. 4 is a schematic cross sectional view taken along line 2-2 in FIG. 1 showing the plunger in a third position;

FIG. 5 is a schematic perspective view of a second embodiment of a brush assembly constructed according to the principles of the present invention;

FIG. 6 is a perspective view of a third embodiment of a brush assembly constructed according to the principles of the present invention; and

FIG. 7 is a perspective view of a cartridge with a portion of the sidewall removed that is used in conjunction with the brush assembly depicted in FIG. 6.

### DETAILED DESCRIPTION OF THE INVENTION

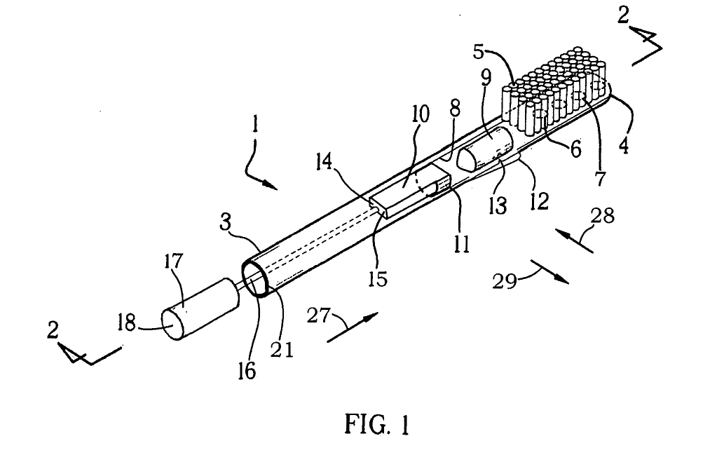

Referring to FIG. 1, the precision flowable material dispensing system 1 of the present invention may be used, for example, in conjunction with a toothbrush having a handle 3. While a toothbrush is depicted for the purpose of explaining the principles of the present invention, any type of brush for any intended use may be similarly employed. The toothbrush handle 3 is seen to terminate at a head 4 which serves as a mounting platform for a plurality of bristles 5. The head 4 includes a series of orifices or perforations, such as orifices 6 and 7, for example, which are in fluid communication with a channel 8 formed within the brush handle 3. The orifices 6 and 7 are preferably of a diameter that is compatible with the expected viscosity of any fluid that may be expected to travel through them. Thus, a relative high viscosity material such as a paste would require relatively larger orifices, while a relative low viscosity material would require a relatively smaller array of orifices approaching the characteristics of a perforated screen.

Housed within the handle 3 is a cartridge 9 which is constructed so as to contain some type of flowable material. The cartridge 9 is formed to have a relatively thin shell and is typically composed of a nontoxic plastic material. Within the cartridge 9 is a liquid, paste, cream, gel or putty like substance intended for application to a part of the human body such as the teeth, skin, hair or nails. The substance within cartridge 9 can be a medication such as an antibiotic or anti-inflammatory agent, toothpaste or a cleanser, for example. The cartridge 9 is manufactured to contain a precise quantity of the flowable substance within, and thus the dimensions of cartridge 9 will vary as needed for the material to be applied. In the case of a prescription medication, for example, a user of the dispensing system 1 may receive from a dentist a series of ten cartridges, each containing a progressively smaller amount of the desired medication. Thus each successive cartridge 9 would have dimensions that were relatively smaller than the preceding cartridge. Each cartridge would be labeled according to the order in which it was to be used.

Residing within the handle is a plunger 11, having a partially circular cross section that is only slightly less than the diameter of the channel 8. Formed integrally with the plunger and extending rearwardly therefrom is a substantially rectangular member 15 which includes a rear surface 14. The upper surface of the member 15 is formed as a substantially planar plate 10. A connecting rod 16 is rigidly affixed to the rear surface 14, the rod 16 extending longitudinally within the handle 3 and finally terminating in a region exterior to the handle 3 at a cylinder 17. A surface 18 is formed on the cylinder 17 to permit a user to apply a longitudinal force to the to the connection rod 16 in the direction of arrow 27. A seal 21 is formed within the handle 3 in order to provide a fluid tight seal surrounding the surface of the cylinder 17.

As part of the surface of the handle 3 and residing in a region adjacent to the cartridge 9, a cantilevered arm 12 is formed of a resilient, deformable material. The arm is an integral part of the wall of the handle 3 and includes a projection or pick 13 having a sharp or abrasive characteristic. When the cantilevered arm 12 is manipulated by a user so as to move in the direction of arrow 28, the pick 13 is brought into an abutting relationship with the cartridge 9. As the cantilevered arm 12 continues to move in the direction of arrow 28, the pick 13 eventually punctures the cartridge 9, thereby releasing the contents of cartridge 9 into the channel 8. The resilient nature of the deformable material which forms the cantilevered arm 12 biases the arm to move in the direction of arrow 29 once the force applied by the user is removed from the arm.

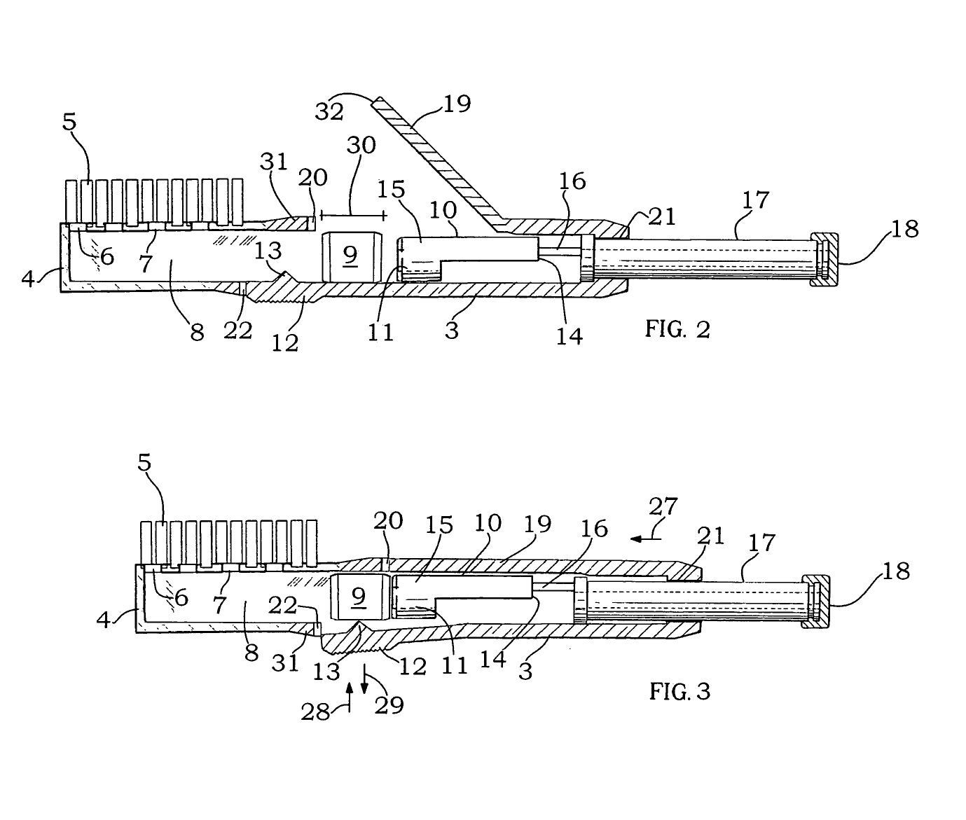

Referring also to FIG. 2, the insertion and advancement of the cartridge 9 may be better appreciated. The handle 3 is formed so as to include a pivotable sidewall which serves as an access port or lid 19. While the lid 19 is shown as being formed in the sidewall 31 of the handle 3, the lid 19 may be positioned so as to provide access to channel 8 via the brush head 4. A seal 20 is formed in the sidewall 31 of the handle 3 to provide a continuous, fluid impermeable seal when the lid 19 is closed and the end 32 of the lid 19 abuts the seal 20. Similarly, the cylinder 17 is surrounded by a seal 30 in order to provide a fluid tight seal. When a user desired to insert a cartridge 9 into the handle 3, the lid 19 is lifted to provide access to the channel 8. The lid 19 may be located on the same side of the handle 3 as the bristles 5 as shown, of the lid 19 may be formed within the handle 3 on a side opposite the bristles 5. In either configuration, once the lid 19 is opened the cartridge 9 is then placed into the channel 8 in a convenient location between the plunger 11 and the head 4 of the brush. As stated previously, the dimensions of the cartridge 9 may vary substantially from one cartridge to another depending on the premeasured quantity of flowable material contained within the cartridge as needed to supply a single sufficient but not excessive quantity of the material to the bristles 5. Thus, the length 30 of the cartridge 9 may be substantially greater or less than the dimension illustrated.

FIG. 3 depicts system 1 shortly after the lid 19 has been closed and the user desires to dispense the flowable material to the bristles 5. The cylinder 17 is advanced as needed to position the cartridge 19 in an abutting relationship with the pick 13. The user becomes aware of the desired position of the cartridge 19 by the deflection or translation of the resilient cantilevered arm 12 in the direction of arrow 29. The user is then able to squeeze or deflect arm 12 in the direction of arrow 28, thereby causing the cartridge 9 to be pierced and permitting the contents of cartridge 9 to escape into the channel 9. In practice, the handle 3 may be surrounded by the palm of the hand of a user while the thumb of the user presses on surface 18 of the cylinder 17. As the cylinder 17 moves in the direction of arrow 27 in response to thumb pressure, the user can simultaneously squeeze the arm 12 with their palm in one continuous movement.

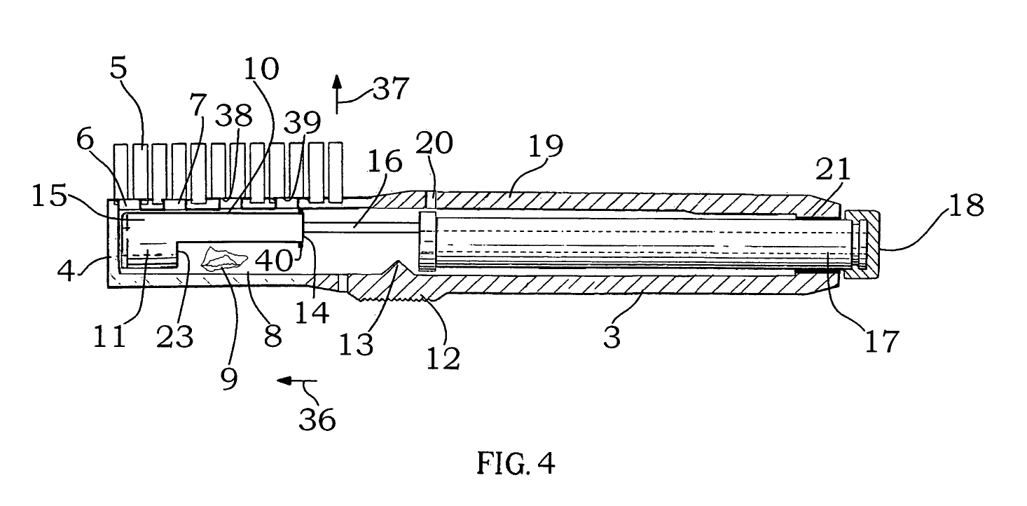

Referring also to FIG. 4, the actual dispensing of the contents of the cartridge 9 can be better understood. The plunger 15 is shown fully advanced in the direction of arrow 36 so as to assume a position beneath the bristles 5. Once the cartridge 9 has been pierced, the contents of the cartridge are also pushed forwardly in the direction of arrow 36. As the region beneath the bristles 5 becomes fully occupied by the plunger 15, the contents of the cartridge 9 are forced upwardly in the direction of arrow 37, where the flowable material is forced through the available orifices 6, 7, 38 and 39. The plate 10 underlies the region beneath all of the orifices once the plunger 10 is fully advanced, thereby urging substantially all of the flowable material to flow through the orifices. A gasket 40 is fitted to the rearmost portion of the plate 10 to prevent fluid flow past the rear surface 14 of the plate 10. When the plunger 11 is subsequently withdrawn from the head 4 of the brush, the punctured and spent cartridge 9 is typically dragged by the rear surface 23 of the plunger 11 into a region of channel 8 that is accessible to the user for subsequent disposal.

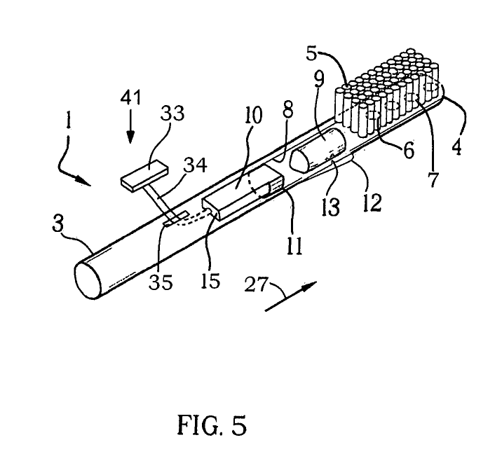

A second embodiment of the present invention is disclosed in FIG. 5. The system 1 uses a plunger 11 which is advanced by a thumb actuated panel 33. A resilient, deformable link 35 is connected to the panel 33, the link 35 being affixed to the rectangular member 15. The link 35 passes through a slot 34 formed in the handle 3. As the panel 33 is pressed in the direction of arrow 41, the link 35 causes the plunger to travel in the direction of arrow 41.

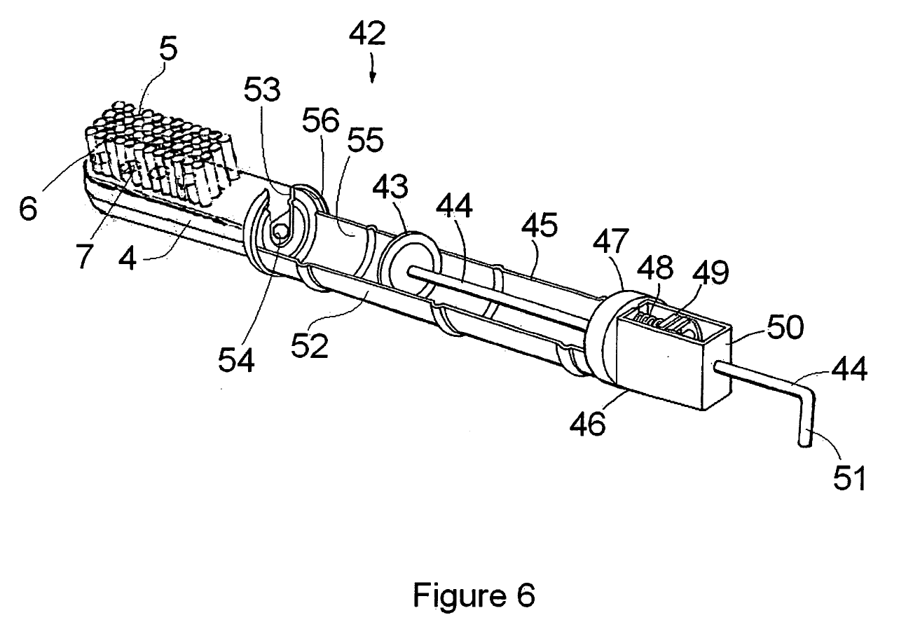

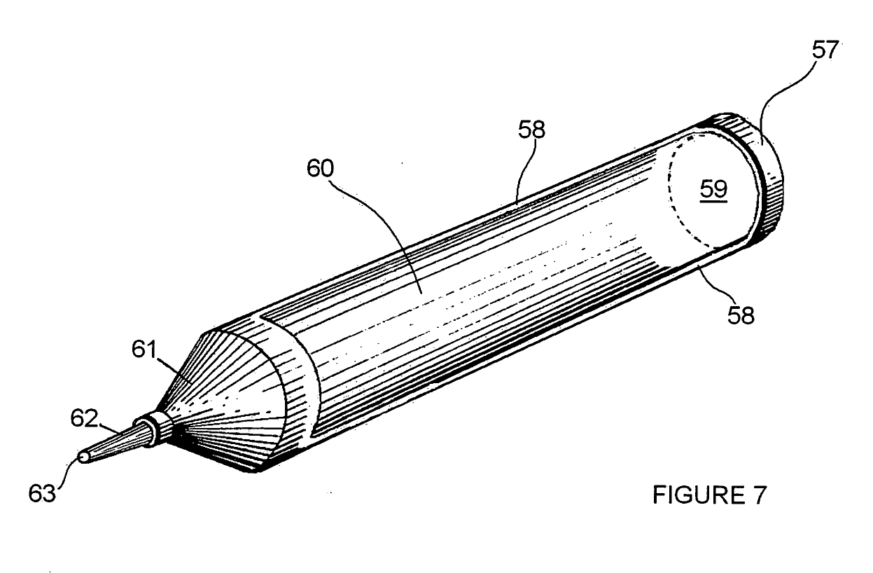

A third embodiment of the present invention is depicted in FIGS. 6 and 7. A substantially cylindrical cartridge 61 is utilized that includes a nozzle 61. An orifice 63 is formed in a tip region of the nozzle 62 that permits the contents 60 of the cartridge 61 to exit the cartridge. The cartridge 61 includes a substantially continuous sidewall 58 that surrounds the flowable contents 60. A movable end wall 59 is formed within the cartridge 61, the end wall 59 initially being biased toward the rear portion 57 of the cartridge due to the pressure exerted by a full volume of the cartridge contents 60. The end wall 59 is a disc that is mounted and dimensioned so as to slide within the surrounding sidewall 58.

The cartridge 61 is mounted within the lidless cavity 55 formed within the brush handle 52 by the handle sidewalls 45. The cartridge 61 is retained in place by a lip 56 which includes a cutout region 53 that simplifies insertion of the cartridge 61 into the cavity 55. A plunger 43 abuts the end wall 59 of the cartridge 61 while a portion of the nozzle 62 extends through an orifice 54 formed within the brush head 4. A shaft 44 connects the plunger 43 to a user accessible handle 51. A housing 46 affixed to the rear bearing surface 47 of the brush handle 52 contains a spring 48 and grip 49 that together tend to retain the shaft 44 in whatever location the shaft currently occupies, the force of the grip being readily overcome by application of a longitudinal force to the shaft 44 via handle 51. As the contents 60 of the cartridge 61 are consumed, the shaft 44 is advanced causing the plunger 43 to apply pressure to the cartridge end wall 59, thereby further urging the cartridge contents 60 through the orifice 63 and into the brush head 4.

While certain forms of the system 1 have been illustrated, the invention is not limited to the specific arrangement of the components and the specific function of the data processing steps as described and shown. Various changes may be made by those skilled in this field to the specific embodiments as described without departing from the scope of the invention. In particular, the method of advancing the plunger 11 may employ many alternative schemes while still utilizing the concept of applying a premeasured single dose flowable material to a brush bristle 5. Further, the cartridge 9 may be located directly within the brush head 4 if the dimensions of the brush are sufficient. While the lid 19 as disclosed is hinged, the lid can be modified to slide and thereby provide access to the channel 8. Similarly, the shape of the cartridge 9 may be modified so as to fill only a portion of channel 8, or the cartridge 9 may be composed of several discrete packages that are loaded into the channel 8 simultaneously in order to achieve the desired single dose quantity. Also, for example, the pick 13 may be placed on an inner wall of the brush head 4 or directly on the plunger 11. The true scope of the invention is defined by the claims.

What is claimed is:

1. A system for dispensing a precise quantity of a flowable material to a brush bristle, comprising:
a brush handle;
a channel formed within the brush handle;
a brush head, the brush head supporting the brush bristle, the brush head being formed to include at least one orifice so as to permit the brush bristle to be in fluid communication with the channel; and
a cartridge, the cartridge residing within the brush handle, the cartridge containing the flowable material, the cartridge being adapted to discharge the flowable material into the channel.

2. A system according to claim 1 wherein the flowable material is at least one of:
(a) a liquid;
(b) a paste;
(c) a cream;
(d) a gel; and
(e) a putty.

3. A system according to claim 2 further comprising a plunger, the plunger residing within the brush handle, the plunger being movable so as to urge at least some contents of the cartridge toward the brush head.

4. A system according to claim 3 wherein the cartridge contains a safe and effective amount of a prescription medication.

5. A system according to claim 4 wherein the plunger further comprises a plate, the plate being a substantially planar surface, the plate tending to urge substantially all of the flowable material through the orifice.

6. A system according to claim 5 wherein the handle further comprises
a lid, the lid providing access to the channel so as to permit insertion of the cartridge into the channel.

7. A system according to claim 6 further comprising a pick, the pick being adapted to puncture the cartridge, thereby permitting the flowable material within the cartridge to enter the channel.

8. A system according to claim 7 further comprising a cantilevered arm, the cantilevered arm being formed integrally with the handle, the pick being mounted on the cantilevered arm, thereby permitting manipulation of the cantilevered arm to advance the pick toward the cartridge.

9. A system according to claim 8 wherein the handle has a bristle side and an opposite side, the lid being located on the bristle side of the handle.

10. A system according to claim 8 wherein the handle has a bristle side and an opposite side, the lid being located on the opposite side of the handle.

11. A system according to claim 8, further comprising a plurality of discrete cartridges, each cartridge comprising a partial dose of a prescription medication.

12. A system according to claim 11 wherein multiple cartridges are placed within the channel simultaneously so as to provide a desired single dose of prescription medication to the bristle.

13. A system according to claim 12, further comprising:
(a) a slot, the slot being formed within the handle;
(b) a lever, the lever having a first end and a second end, the lever passing through the slot, the first end of the lever being affixed to the plunger; and
(c) a panel, the panel being affixed to the second end of the lever such that a force applied to the panel is transferred in an orthogonal direction to the plunger so as to urge the plunger toward the brush head.

14. A system for delivering a medication to a toothbrush, comprising:
(a) a toothbrush head;
(b) a plurality of bristles affixed to the toothbrush head;
(c) a hollow toothbrush handle, the hollow toothbrush handle being in fluid communication with the bristles;
(d) a thumb operated cylinder extending longitudinally into a portion of the hollow toothbrush handle;
(e) a plunger, the plunger being affixed to the cylinder such that thumb pressure applied to the cylinder urges the plunger toward the toothbrush head; and
(f) a cartridge, the cartridge containing an effective and nonexcessive amount of the medication, the cartridge being urged toward the toothbrush head by the plunger so as to permit the medication within the cartridge to be dispensed within the toothbrush head.

15. The system of claim 14, further comprising a perforated screen, the screen being interposed between the bristles and the cartridge so as to evenly disperse the medication onto the bristles.

16. The system of claim 15, further comprising at least one access port, the access port providing a path for insertion of the cartridge into the hollow toothbrush handle.

17. A system according to claim 16 wherein the access port is located in a sidewall of the hollow toothbrush handle, the access port being formed integrally with the sidewall and being hinged with respect to the sidewall by means of a resilient, deformable material used to form the hollow toothbrush handle.

18. A system according to claim 17 further comprising at least one pick, each pick residing within the hollow toothbrush handle, each pick tending to puncture the cartridge when the cartridge is in an abutting relationship with the pick.

19. A system according to claim 18 wherein the plunger further comprises a rear surface, the rear surface tending to capture the cartridge as the plunger is withdrawn from the hollow toothbrush handle after the medication within the cartridge has been dispensed.

20. A method for dispensing a precise amount of a flowable material onto a plurality brush bristles mounted on a brush head, comprising the activities of:
(a) forming a region within the brush head adapted to receive a cartridge containing the precise amount of the flowable material;
(b) forming a plurality of orifices within the brush head so that the brush bristles are in fluid communication with the region within the brush head;
(c) inserting the cartridge into the region within the brush head; and
(d) applying a force to the cartridge, the force being sufficient to puncture the cartridge and urge the flowable material through the orifices and onto the brush bristles.
